(19) United States
(12) Patent Application Publication
(10) Pub. No.: US 2014/0180669 A1
(43) Pub. Date: Jun. 26, 2014

(54) PATENT APPLICATION FILE CONVERSION SYSTEM AND METHOD

(71) Applicants: HON HAI PRECISION INDUSTRY CO., LTD., New Taipei (TW); HONG FU JIN PRECISION INDUSTRY (ShenZhen) CO.,LTD., Shenzhen (CN)

(72) Inventors: CHUNG-I LEE, New Taipei (TW); DE-YI XIE, Shenzhen (CN); HAI-YUN CHEN, Shenzhen (CN); AN-SHENG LUO, Shenzhen (CN)

(73) Assignees: HON HAI PRECISION INDUSTRY CO., LTD., New Taipei (TW); HONG FU JIN PRECISION INDUSTRY (ShenZhen) CO.,LTD., Shenzhen (CN)

(21) Appl. No.: 14/014,509

(22) Filed: Aug. 30, 2013

(30) Foreign Application Priority Data
Dec. 24, 2012 (CN) 2012105642814

(51) Int. Cl. G06F 17/28

(52) U.S. Cl. CPC G06F 17/28
USPC 704/2

(57) ABSTRACT

A computer reads a patent application file from a database connected to the computer, and inserts content of the patent application file into a first file format. The computer converts the content of the patent application file in the first file format using a language converting API, and inserts the converted content from the first file format into a second file format. The computer replaces error words with correct words corresponding to the error words, in response to a determination that the converted content in the second file format comprises error words.

### BACKGROUND

1. Technical Field

The embodiments of the present disclosure relate to management technology, and particularly to a patent application file conversion system and method.

2. Description of Related Art

Simplified Chinese are based on traditional Chinese. Most words in simplified Chinese have the same meaning as the words in traditional Chinese. However, there are still some other differences between traditional Chinese and simplified Chinese. For example, the word “ [symbol] ” in simplified Chinese corresponds to the word “ [symbol] ” in traditional Chinese, which both means claim in English. At present, translation between the simplified Chinese and the traditional Chinese is to translate every character one by one. However, the translated words may be not correct after the translation. For example, the word “ [symbol] ” in simplified Chinese is translated into the word it “ [symbol] ” in traditional Chinese, but the translated word “ [symbol] ” are not correct in traditional Chinese. Thus, a user may have to take a lot of time to check and recheck the translated words to make sure they make sense and are the correct translated words. For example, if the translated word is “ [symbol] ” in traditional Chinese, the user may manually correct the translated word from “ [symbol] ” to “ [symbol] ” in traditional Chinese. Therefore, there is room for improvement in the art.

### BRIEF DESCRIPTION OF THE DRAWINGS

FIG. 1 is a block view of one embodiment of a computer including a patent application file conversion system.

FIG. 2 is a block diagram of one embodiment of function modules of the patent application file conversion system included in the computer in FIG. 1.

FIG. 3 is a flowchart of one embodiment of a patent application file conversion method.

FIG. 4 illustrates a simplified Chinese word list.

FIG. 5 illustrates a traditional Chinese word list.

FIG. 6 illustrates a simplified Chinese file format.

FIG. 7 illustrates a traditional Chinese file format.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

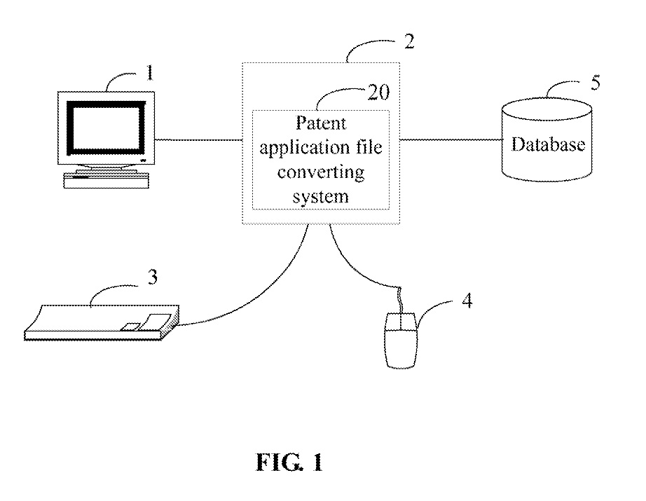

FIG. 1 is a block diagram of one embodiment of a computer 2. In this embodiment, the computer 2 includes a patent application file conversion system 20. A plurality of peripherals are electronically connected to the computer 2, such as a display device 1, a keyboard 3, and a mouse 4. The peripherals may be used to input or output various computer signals or interfaces. The computer 2 electronically connects to a database 5 using open database connectivity (ODBC) or JAVA database connectivity (JDBC), for example. The database 5 may store a patent application file. The patent application file may be written in simplified Chinese for filing to the State Intellectual Property Office of the People's Republic of China (hereafter “SIPO”). The patent application file may also be written in traditional Chinese for filing to Taiwan Intellectual Property Office (hereafter “TIPO”). The patent application file may be, but are not limited to, a WORD file, a PDF file, a TXT file, an extensible markup language (XML) file or a hypertext markup language (HTML) file.

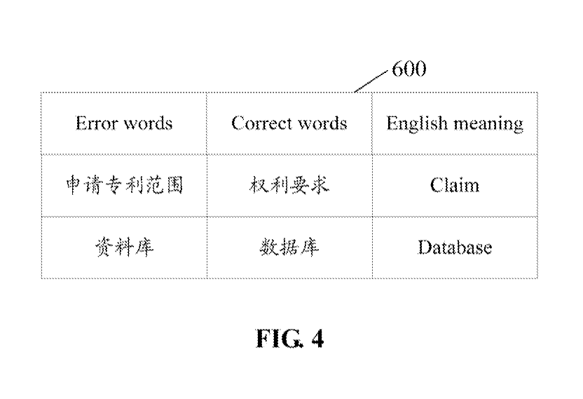

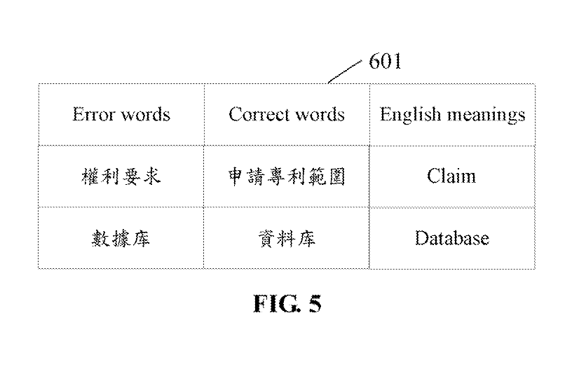

The database 5 also stores a simplified Chinese word list 600 as shown in FIG. 4 and a traditional Chinese word list 601 as shown in FIG. 5. Both the simplified Chinese word list 600 and the traditional Chinese word list 601 include one ore more error words and correct words. For better understanding of this invention, FIG. 4 and FIG. 5 also include an explanation in English for each simplified Chinese word or each traditional Chinese word. The one or more error words and correct words in simplified Chinese word list 600 are simplified Chinese, and the one or more error words in simplified Chinese word list 600 are wrong in simplified Chinese, because the one or more error words in simplified Chinese does not obey syntax of simplified Chinese, for example, in simplified Chinese, the word “ [symbol] ” in simplified Chinese means “claim” in English, and “ [symbol] ” does not exist in simplified Chinese, thus “ [symbol] [symbol] ” is the error word in simplified Chinese. The one or more error words and correct words in traditional Chinese word list 601 are traditional Chinese, and the one or more error words in traditional Chinese word list 600 are wrong in traditional Chinese, because the one or more error words in traditional Chinese does not obey syntax of traditional Chinese, for example, in traditional Chinese, the word “ [symbol] ” in traditional Chinese means “claim” in English, and “ [symbol] ” does not exist in traditional Chinese, thus “ [symbol] ” is the error word in traditional Chinese. Additionally, each error word corresponds to a correct word. For example, as shown in FIG. 4, the error word “ [symbol] ” corresponds to the correct word “ [symbol] ” which means “claim” in English, and the error word “ [symbol] ” corresponds to the correct word “ [symbol] ” which means “database” in English. For example, as shown in FIG. 5, the error word “ [symbol] ” corresponds to the correct word “ [symbol] ” which means “claim” in English, and the error word “ [symbol] ” corresponds to the correct word “ [symbol] ” which means “database” in English. The error words and the correct words are predetermined by a user, and the user can add or delete the error words and correct words in simplified Chinese word list 600 and the traditional Chinese word list 601.

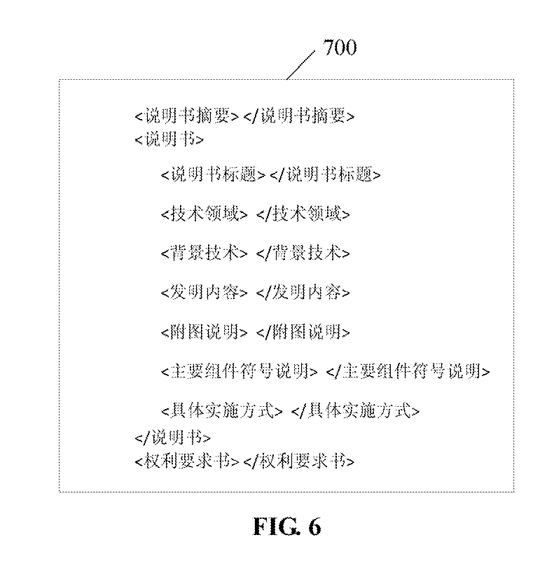

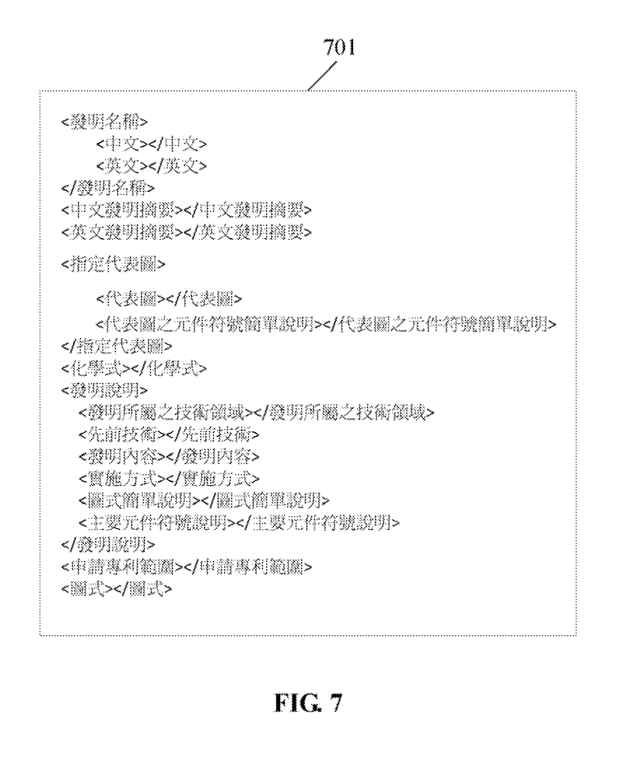

The database 5 further stores a simplified Chinese file format 700 as shown in FIG. 6 and a traditional Chinese file format 701 as shown in FIG. 7. The simplified Chinese file format 700 is predetermined according to an official form of the SIPO, for example, the simplified Chinese file format 700 includes tags, such as “< [symbol] ></ [symbol] >” as shown in FIG. 6, which is a counterpart of “abstract” in US patent application format. The traditional Chinese file format 701 is predetermined according to an official form of the TIPO, for example, the traditional Chinese file format 701 includes the tags, such as “< [symbol] ></ [symbol] >” as shown in FIG. 7, which is the counterpart of “abstract” in US patent application format.

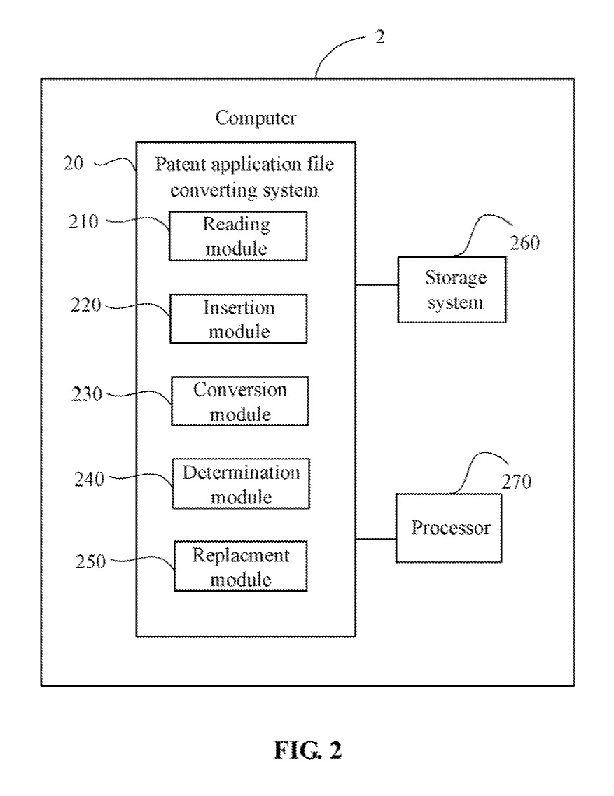

FIG. 2 is a block diagram of one embodiment of function modules of the patent application file conversion system 20 included in the computer 2 of FIG. 1. The patent application file conversion system 20 is used to convert a patent application file. In one embodiment, the computer 2 includes a storage system 260, and at least one processor 270. In one embodiment, the patent application file conversion system 20 includes a reading module 210, an insertion module 220, a conversion module 230, a determination module 240, and a replacement module 250. The modules 210-250 may include computerized code in the form of one or more programs that are stored in the storage system 260. The computerized code includes instructions that are executed by the at least one processor 270 to provide functions for the modules 22-26. The storage system 260 may be a memory, such as an EPROM memory chip, hard disk drive (HDD), or flash memory stick.

The reading module 210 reads a patent application file from the database 5.

The insertion module 220 inserts content of the patent application file into a first file format. In one embodiment, the insertion module 220 determines if the patent application is written in simplified Chinese or in traditional Chinese. If the patent application is written in simplified Chinese, and the first file format is selected as the simplified Chinese file format 700, the content of the patent application file is inserted into the simplified Chinese file format 700. If the patent application is written in traditional Chinese, and the first file format is selected as the traditional Chinese file format 701, the content of the patent application file is inserted into the traditional Chinese file format 701.

The conversion module 230 converts the content of the patent application file in the first file format using a language converting application programming interface (API). The language converting API includes a traditional Chinese character set and a simplified Chinese character set, and is used to convert characters between the traditional Chinese and the simplified Chinese. For example, the traditional Chinese character “ [symbol] ” is converted to traditional Chinese character “ [symbol] ” by the language converting API. In one embodiment, if the first file format is the simplified Chinese file format 700, the conversion module 230 converts the content of the patent application file in the first file format from the simplified Chinese to the traditional Chinese, the converted content is in traditional Chinese. If the first format is the traditional Chinese file format 701, the conversion module 230 converts the content of the patent application file in the first file format from the traditional Chinese to the simplified Chinese, the converted content is in simplified Chinese.

The insertion module 220 inserts the converted content from the first file format into a second file format. In one embodiment, the first file format and the second file format are different. For example, when the first file format is the simplified Chinese file format 700, the second file format is the traditional Chinese file format 701. When the first file format is the traditional Chinese file format 701, the second file format is the simplified Chinese file format 700.

The determination module 240 determines if the converted content in the second file format includes error words. In one embodiment, when the second file format is the simplified Chinese file format 700, the determination module 240 determines if one or more error words in simplified Chinese word list 600 exist in the second file format. When the second file format is the traditional Chinese file format 701, the determination module 240 determines if one or more error words in traditional Chinese word list 601 exist in the second file format.

The replacement module 250 replaces the error words with the correct words corresponding to the error words, in response to a determination that the second file format includes error words. In one embodiment, when the second file format includes error words in simplified Chinese word list 600, the replacement module 250 replaces the error words with the correct words in simplified Chinese word list 600. When the second file format includes error words in traditional Chinese word list 601, the replacement module 250 replaces the error words with the correct words in traditional Chinese word list 601.

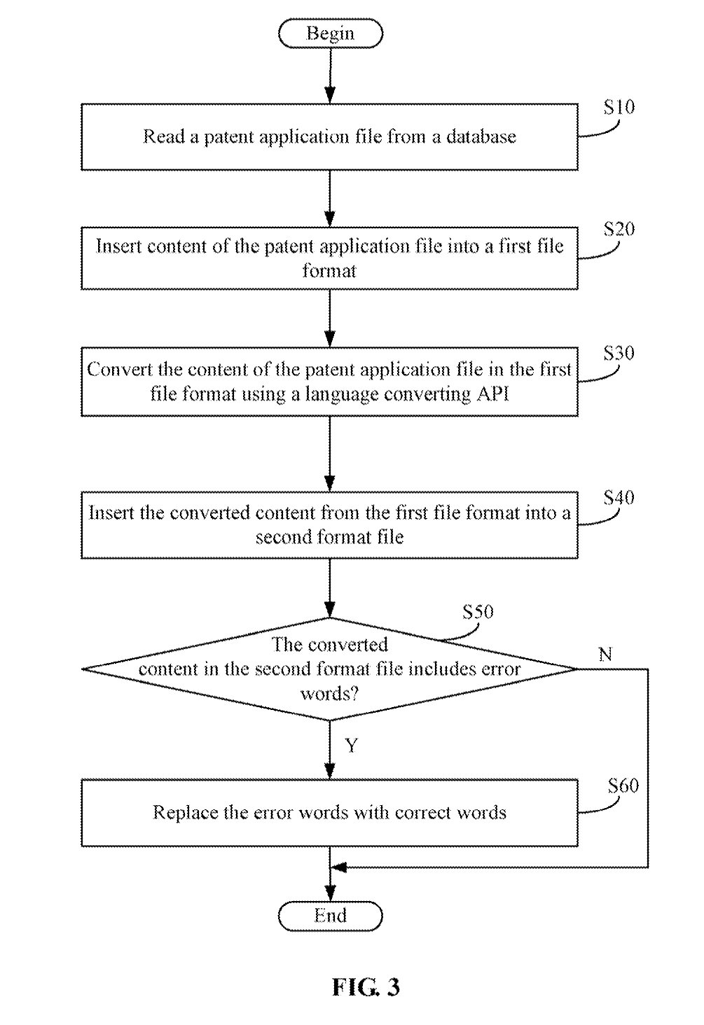

FIG. 3 is a flowchart of one embodiment of a patent application file conversion method. Depending on the embodiment, additional steps may be added, others deleted, and the ordering of the steps may be changed.

In step S10, the reading module 210 reads a patent application file from a database 5. The patent application file may be written in simplified Chinese or be written in traditional Chinese.

In step S20, the insertion module 220 inserts content of the patent application file into a first file format. In one embodiment, if the patent application is written in simplified Chinese, and the first file format is the simplified Chinese file format 700, the content of the patent application file is inserted into the simplified Chinese file format 700. In one embodiment, if the patent application file is written in simplified Chinese, the patent application file is consisted with many parts consistent with the rules and regulations of the SIPO, such as an abstract, a technical filed, a summary, a description of related art, a brief description of the drawings, a detailed description, and claims, which is similar to a US patent application. Each part corresponds to two tags in simplified Chinese file format, and the insertion module 220 inserts the content of the patent application into the first file format according to the tags. For example, the abstract of the patent application file corresponds to the two tags “< [symbol] ></ [symbol] >”, the abstract (e.g., XXXX) of the patent application file is inserted between the two tags “< [symbol] >XXXX</ [symbol] >.”

If the patent application is written in traditional Chinese, and the first file format is the traditional Chinese file format 701, the content of the patent application file is inserted into the traditional Chinese file format 701. In one embodiment, if the patent application file is written in traditional Chinese, the patent application file is consisted with many parts consistent with the rules and regulations of the SIPO, such as an abstract, a technical filed, a Chinese summary, an English summary, a description of related art, a brief description of the drawings, a detailed description, and claims. Each part corresponds to two tags in traditional Chinese file format, and the insertion module 220 inserts the content of the patent application into the first file format according to the tags. For example, the abstract of the patent application file corresponds to the tags “< [symbol] [symbol] ></ [symbol] >”, the abstract (e.g., YYYY) of the patent application file is inserted between the two tags “< [symbol] >YYYY</ [symbol] >.”

In step S30, the conversion module 230 converts the content of the patent application file in the first file format using a language converting API. In one embodiment, if the first format is the simplified Chinese file format 700, the conversion module 230 converts the content of the patent application file in the first file format from the simplified Chinese to the traditional Chinese, then the converted content is in traditional Chinese. If the first format is the traditional Chinese file format 701, the conversion module 230 converts the content of the patent application file in the first file format from the traditional Chinese to the simplified Chinese, the converted content is in simplified Chinese.

In step S40, the insertion module 220 inserts the converted content from the first file format into a second file format. In one embodiment, the first file format and the second file format are different. For example, when the first file format is the simplified Chinese file format 700, and the second file format is the traditional Chinese file format 701. When the first file format is the traditional Chinese file format 701, and the second file format is the simplified Chinese file format 700.

In step S50, the determination module 240 determines if the converted content in the second file format includes error words. In one embodiment, when the second file format is the simplified Chinese file format 700, if one or more error words in simplified Chinese word list 600 exist in the second file format, the procedure goes to step S60. Otherwise, if no error word in simplified Chinese word list 600 exists in the second file format, the procedure ends. When the second file format is the traditional Chinese file format 701, if one or more error words in traditional Chinese word list 601 exist in the second file format, the procedure goes to S60. Otherwise, if no error word in traditional Chinese word list 601 exists in the second file format, the procedure ends.

In step S60, the replacement module 250 replaces the error words with the correct words corresponding to the error words. In one embodiment, when the second file format includes the error word “ [symbol] ,” the replacement module 250 replaces the error word with the correct words “ [symbol] .” In one embodiment, when the second file format includes the error word “ [symbol] ,” the replacement module 250 replaces the error word with the correct word “ [symbol] .”

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer, comprising:
at least one processor; and
a storage system that stores one or more programs, when executed by the at least one processor, cause the at least one processor to perform a patent application file conversion method, the method comprising:
reading a patent application file from a database connected to the computer;
inserting content of the patent application file into a first file format;
converting the content of the patent application file in the first file format using a language converting application programming interface (API);
inserting the converted content from the first file format into a second file format;
determining whether the converted content in the second file format comprises error words; and
replacing the error words with correct words corresponding to the error words, in response to a determination that the converted content in the second file format comprises error words.

2. The computer of claim 1, wherein when the patent application is written in simplified Chinese, the first file format is a simplified Chinese file format, and the second file format is a traditional Chinese file.

3. The computer of claim 2, wherein the content of the patent application file in the first file format is converted from the traditional Chinese to the simplified Chinese.

4. The computer of claim 2, wherein the error words and the correct words are simplified Chinese and are predetermined in a simplified Chinese word list, and each error word corresponds to a correct word.

5. The computer of claim 1, wherein when the patent application is written in traditional Chinese, the first file format is a traditional Chinese file format, and the second file format is a simplified Chinese file.

6. The computer of claim 5, wherein the content of the patent application file in the first file format is converted from the simplified Chinese to the traditional Chinese.

7. The computer of claim 5, wherein the error words and the correct words are the traditional Chinese and are predetermined in a traditional Chinese word list, and each error word corresponds to a correct word.

8. A patent application file conversion method implemented by a computer, the method comprising:
reading a patent application file from a database connected to the computer;
inserting content of the patent application file into a first file format;
converting the content of the patent application file in the first file format using a language converting application programming interface (API);
inserting the converted content from the first file format into a second file format;
determining whether the converted content in the second file format comprises error words; and
replacing the error words with correct words corresponding to the error words, in response to a determination that the converted content in the second file format comprises error words.

9. The method of claim 8, wherein when the patent application is written in simplified Chinese, the first file format is a simplified Chinese file format, and the second file format is a traditional Chinese file.

10. The method of claim 9, wherein the content of the patent application file in the first file format is converted from the traditional Chinese to the simplified Chinese.

11. The method of claim 9, wherein the error words and the correct words are the simplified Chinese and are predetermined in a simplified Chinese word list, and each error word corresponds to a correct word.

12. The method of claim 8, wherein when the patent application is written in traditional Chinese, the first file format is a traditional Chinese file format, and the second file format is a simplified Chinese file.

13. The method of claim 12, wherein the content of the patent application file in the first file format is converted from the simplified Chinese to the traditional Chinese.

14. The method of claim 12, wherein the error words and the correct words are the traditional Chinese and are predetermined in a traditional Chinese word list, and each error word corresponds to a correct word.

15. A non-transitory computer-readable medium having stored thereon instructions that, when executed by a computer, causing the computer to perform a patent application file conversion method, the method comprising:
reading a patent application file from a database connected to the computer;
inserting content of the patent application file into a first file format;
converting the content of the patent application file in the first file format using a language converting application programming interface (API);
inserting the converted content from the first file format into a second file format;
determining whether the converted content in the second file format comprises error words; and
replacing the error words with correct words corresponding to the error words, in response to a determination that the converted content in the second file format comprises error words.

16. The non-transitory computer-readable medium of claim 15, wherein when the patent application is written in simplified Chinese, the first file format is a simplified Chinese file format, and the second file format is a traditional Chinese file.

17. The non-transitory computer-readable medium of claim 16, wherein the content of the patent application file in the first file format is converted from the traditional Chinese to the simplified Chinese.

18. The non-transitory computer-readable medium of claim 16, wherein the error words and the correct words are the simplified Chinese and are predetermined in a simplified Chinese word list, and each error word corresponds to a correct word.

19. The non-transitory computer-readable medium of claim 15, wherein when the patent application is written in traditional Chinese, the first file format is a traditional Chinese file format, and the second file format is a simplified Chinese file, the content of the patent application file in the first file format is converted from the simplified Chinese to the traditional Chinese.

20. The non-transitory computer-readable medium of claim 14, wherein the error words and the correct words are the traditional Chinese and are predetermined in a traditional Chinese word list, and each error word corresponds to a correct word.
